(19) United States
(12) Patent Application Publication
(10) Pub. No.: US 2010/0230488 A1
(43) Pub. Date: Sep. 16, 2010

(54) Dual Tendering for Chair Massages on Academic Campuses

(75) Inventor: Franklin Taylor, Williamsburg, VA (US)

Correspondence Address: WILLIAM AND MARY TECHNOLOGY TRANSFER OFFICE, 519 RICHMOND RD, SAVAGE HOUSE, PO BO 8795, WILLIAMSBURG, VA, 23187-8795, US

(73) Assignee: COLLEGE OF WILLIAM AND MARY, Williamsburg, VA (US)

(21) Appl. No.: 12/403,690

(22) Filed: Mar. 13, 2009

(51) Int. Cl. G06F 7/08

(52) U.S. Cl. 235/381

(57) ABSTRACT

The accessibility of chair massages on an academic campus is improved by modifying an electronic currency acceptor to interface with a multi-drop bus (MDB) card reader. The electronic currency acceptor so-modified with the MDB card reader is then installed on a vending massage chair to thereby form an updated vending massage chair. The updated vending massage chair is placed at a location in a building on an academic campus.

### FIELD OF THE INVENTION

The field of the invention relates to vending massage chairs, and more particularly to a method of improving the accessibility of such vending massage chairs on an academic campus by increasing the number of payment options for utilizing same.

### BACKGROUND OF THE INVENTION

Vending massage chairs are currently equipped with currency acceptors and/or credit card readers. Such vending massage chairs are placed in locations where busy consumers can purchase short chair massages. Currently, a chair massage “purchaser” is assumed to be a consumer with ready access to cash or a credit card. However, this assumption has the effect of excluding a number of possible consumers.

### SUMMARY OF THE INVENTION

Accordingly, it is an object of the present invention to provide a method that improves/increases the accessibility of vending massage chairs to a broader consumer population.

Other objects and advantages of the present invention will become more obvious hereinafter in the specification and drawings.

In accordance with the present invention, a method is provided to improve the accessibility of chair massages on an academic campus. An electronic currency acceptor is modified to interface with a multi-drop bus (MDB) card reader. The electronic currency acceptor so-modified with the MDB card reader is then installed on a vending massage chair to thereby form an updated vending massage chair. The updated vending massage chair is placed at a location in a building on an academic campus.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a block diagram of a dual tender assembly to include a multi-drop bus (MDB) card reader for use in the present invention;

FIG. 2 is a side schematic view of an updated vending massage chair in accordance with an embodiment utilized by the present invention;

FIG. 3 is a front schematic view of the updated vending massage chair illustrated in FIG. 2; and

FIG. 4 is a side schematic view of an updated vending massage chair in accordance with another embodiment utilized by the present invention.

### DETAILED DESCRIPTION OF THE INVENTION

The present invention is a method that, when implemented in accordance with the process described herein, will make vending massage chairs more accessible to a broad consumer population to include students and other members of an academic campus population. As used herein, the term “academic campus” refers to the grounds and buildings that comprise the facilities of a college, university, boarding school, or other academic institution. Briefly, the present invention will make vending massage chairs more accessible on academic campuses by increasing the payment options that can be used to purchase time on a vending massage chair by a typical member of an academic campus. In general, this will be accomplished by equipping a vending massage chair with the capability to accept payment from a campus account card typically carried by a member of an academic campus. As used herein, the term “campus account card” refers to a smart card containing machine-readable information that identifies a campus user (e.g., student, faculty, administrator, etc.) and his/her school account. A campus account card typically functions as a debit card linked to a pre-paid account balance that can be replenished with additional deposits.

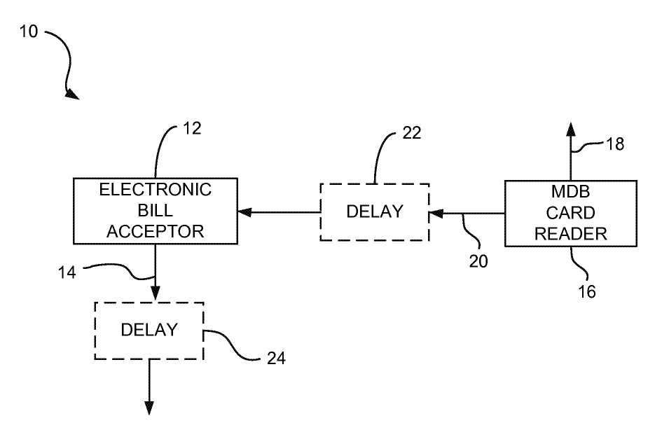

Referring now to the drawings and more particularly to FIG. 1, a dual tender assembly in accordance with an embodiment of the present invention is shown and is referenced generally by numeral 10. Dual tender assembly 10 includes an electronic bill acceptor 12 that has been removed from an existing vending massage chair (not shown). Bill acceptor 12 can be any of a variety of bill acceptors that generates an activation signal (designated by arrow 14) when a correct amount of payment (i.e., in the form of script money) has been inserted therein. In the case of a vending massage chair, activation signal 14 starts a massage session.

In accordance with the present invention, dual tender assembly 10 is formed by interfacing a multi-drop bus (MDB) card reader 16 to bill acceptor 12. Typical MDB card readers include a card swipe device that reads information from a campus user's campus account card, a communication system for transmitting the information so-read (indicated by arrow 18) to a campus transaction system (not shown), and a display so that a campus user can view information related to the transaction initiated when the campus account card is swiped through the card swipe device. A variety of MDB card readers having these capabilities are known in the art and are commercially available. By way of example, one such MDB card reader is the VR/MDB2 vending machine reader manufactured by Blackboard Inc. This MDB card reader provides for communication with a campus transaction system's server using an RS-485 or IP (10/100 Base-T Ethernet) connection. As used herein, the term “campus transaction system” refers to an integrated system that administers on-line, real-time commerce on an academic-campus. A widely-used campus transaction system is available from Blackboard Inc.

In addition to transmitting information 18 to a campus transaction system, MDB card reader 16 provides bill acceptor 12 with a signal 20 indicative of an amount required for a chair massage. That is, signal 20 causes bill acceptor 12 to operate as if script money was inserted into bill acceptor 12. Accordingly, upon receipt of signal 20, bill acceptor 12 generates activation signal 14.

For reasons that will become more apparent below, it may be desirable to incorporate a time delay between the generation of signal 20 and the presentation of activation signal 14 to a vending massage chair. As will be explained further below, this time delay should be sufficient to allow a campus user to swipe their campus account card in MDB card reader 16 and then get comfortably situated in the vending massage chair. Typical time delays can range from approximately 15 seconds to 1 minute. The time delay can be incorporated in one or more portions of dual tender assembly 10. For example, a delay 22 can be installed between MDB card reader 16 and bill acceptor 12 to delay the presentation of signal 20 to bill acceptor 12. Additionally or alternatively, a time delay 24 could be installed to delay the presentation of activation signal 14 to a vending massage chair. Note that time delay 14 could also delay the presentation of activation signal 14 to a vending massage chair in the use of a standard cash purchase.

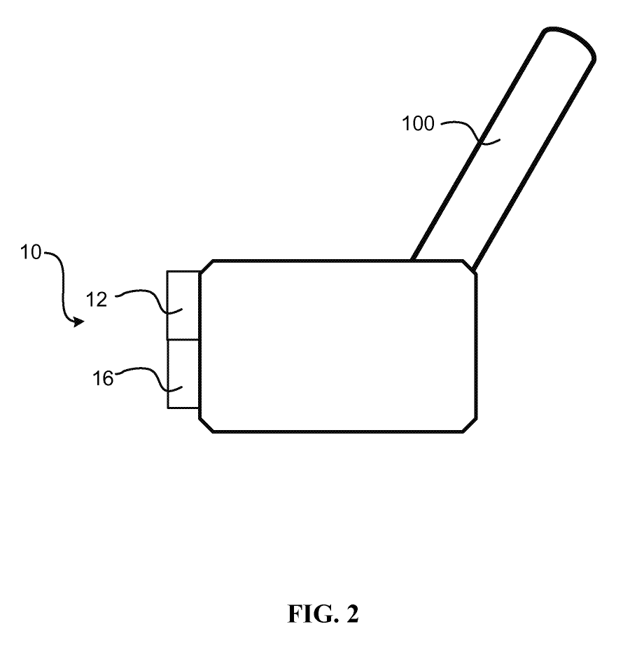

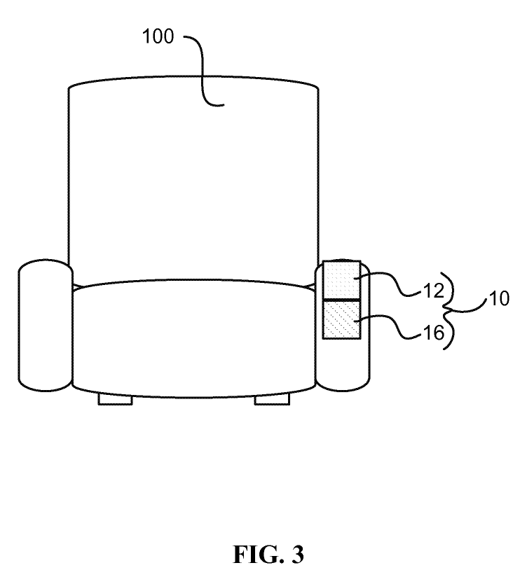

Dual tender assembly 10 is utilized in the present invention by installing same in a vending massage chair as will now be explained with the aid of FIGS. 2 and 3. A typical cash vending massage chair has its bill acceptor located on a front side thereof. To simplify the transformation of a typical vending massage chair to one updated for academic campus use in accordance with the present invention, dual tender assembly 10 will also typically be placed on the front side of a vending massage chair 100 as shown in FIGS. 2 and 3. More specifically, MDB card reader 16 will typically be located below bill acceptor 12. This lower positioning of MDB card reader 16 is most readily accessed by a user before sitting in vending massage chair 100. Therefore, in order to allow a user to purchase a chair massage using MDB card reader 16 and have time to get comfortable in chair 100, the above-described time delay(s) 22/24 can be incorporated in dual tender assembly 10. Note that this lower positioning of MDB card reader 16 may not be ideal for the general population, but it is perfectly acceptable as a payment option location on an academic campus where the vast majority of potential users are young and healthy.

Vending massage chair 100 updated/transformed with dual tender assembly 10 is placed in a building on an academic campus where chair massages would most likely be desired and/or of benefit. Typically, chair 100 would most likely be of interest in buildings where students spend long (and possibly stressful) periods of time working/studying. Accordingly, chair 100 could be placed in libraries and various well-known student study areas. In this way, chair 100 will readily present itself as a reward during times of hard work. By making chair 100 readily available in known study areas, students can take a deserved break without leaving their study site. Furthermore, by making the readily accessible massage chair available for use with a simple swipe of a student's campus account card, the student/consumer has the ability to make an impulse purchase.

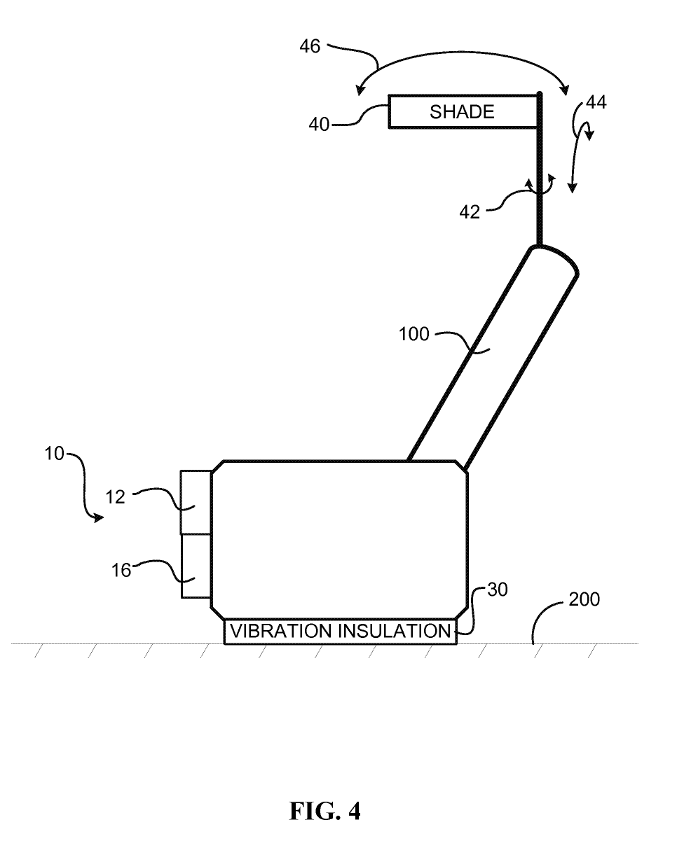

As described above, chair 100 updated/transformed with dual tender assembly 10 will typically be placed in quiet and well-lit study/work areas of an academic campus. In order to maximize the value of chair 100 to users as well as minimize distraction of potential users who may be quietly working in the vicinity of chair 100, one or more additional features can be provided. Referring now to FIG. 4, two such features will be described. It is to be understood that these features are mutually exclusive even though both are shown with chair 100.

Since chair 100 is ideally placed where students will be working quietly and chair 100 typically generates some levels of vibration/noise, vibration insulation 30 can be disposed between chair 100 and a floor surface 200 on which chair 100 is placed. Vibration insulation 30 could take the form of a free-standing mat or could be coupled directly to underside regions of chair 100. Such direct coupling of vibration insulation 30 to chair 100 has the added advantage of allowing a user to alter the position of chair 100 while maintaining the proper position of vibration insulation 30. By reducing the introduction of vibrations into floor surface 200, the experience of the user and potential users working near chair 100 are enhanced. That is, the user will enjoy their massage knowing they are not disturbing those working nearby. The potential users working nearby will see the enjoyment experienced by the user and be enticed to purchase their own massage.

As mentioned above, chair 100 is ideally placed in study/work areas of an academic campus. Since such study/work areas are typically well-lit (e.g., large windows, fluorescent lighting, etc.), a user's massage experience could be enhanced by providing some type of shade apparatus 40 on chair 100. Shade apparatus 40 can be any of a wide variety of light-shading devices/systems that will block some or all of the ambient light incident on a user's eyes when sitting in chair 100. Shade apparatus 40 can include some type of adjustment mechanism that allows a user to reposition shade apparatus 40 in one or more dimensions as indicated by arrows 42, 44 and 46. An added advantage of shade apparatus 40 is that a user can use it for privacy as they shield their face from view by others in the area of chair 100.

The advantages of the present invention are numerous. By adding the payment option of an MDB card reader, the market potential of a vending massage chair is increased by providing wide accessibility to users on an academic campus. Such accessibility improves life for the campus population as a readily accessible vending chair massage will enhance a student's study experience while reducing illness-causing stress.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A method of improving accessibility to chair massages on an academic campus, comprising the steps of:
modifying an electronic currency acceptor to interface with a multi-drop bus (MDB) card reader;
installing said electronic currency acceptor so-modified with said MDB card reader on a vending massage chair wherein an updated vending massage chair is formed; and
placing said updated vending massage chair at a location in a building on an academic campus.

2. A method according to claim 1 wherein said step of modifying includes the step of providing a time delay in said electronic currency acceptor so-modified with said MDB card reader wherein, when payment for use of said updated vending massage chair is made via said MDB card reader, activation of said updated vending massage chair is delayed for a pre-set period of time after said payment.

3. A method according to claim 1 wherein said step of installing includes the step of locating said MDB card reader beneath said electronic currency acceptor on a front side of said modified vending massage chair.

4. A method according to claim 1 wherein said step of placing includes the step of disposing vibration insulation underneath said updated vending massage chair.

5. A method according to claim 4 wherein said step of disposing comprises the step of coupling said vibration insulation to said updated vending massage chair.

6. A method according to claim 1 further comprising the step of coupling light shading means to said updated vending massage chair for at least partially blocking at least one of light sources and views visible when one sits in said updated vending massage chair at said location.

7. A method of improving accessibility to chair massages on an academic campus, comprising the steps of:
modifying an electronic currency acceptor to interface with a multi-drop bus (MDB) card reader wherein a dual tender assembly is formed;
programming a time delay in said dual tender assembly wherein, when payment is made via said MDB card reader thereof, an activation signal generated by said dual tender assembly is delayed for a pre-set period of time after said payment;
installing said dual tender assembly on a vending massage chair wherein an updated vending massage chair is formed;
placing said updated vending massage chair at a location in a building on an academic campus;
disposing vibration insulation underneath said updated vending massage chair; and
coupling light shading means to said updated vending massage chair for at least partially blocking at least one of light sources and views visible when one sits in said updated vending massage chair at said location.

8. A method according to claim 7 wherein said step of installing locates said dual tender assembly on a front side of said updated vending massage chair with said MDB card reader thereof positioned beneath said electronic currency acceptor thereof.

9. A method according to claim 7 wherein said step of disposing comprises the step of coupling said vibration insulation to said updated vending massage chair.

10. A method of increasing payment options for chair massages on an academic campus, comprising the steps of:
providing a vending massage chair having an electronic currency acceptor incorporated therein;
removing said electronic currency acceptor from said vending massage chair;
modifying said electronic currency acceptor to interface with a multi-drop bus (MDB) card reader wherein a dual tender assembly is formed; and
installing said dual tender assembly on a front side of said vending massage chair wherein an updated vending massage chair is formed, said MDB card reader of said dual tender assembly being located below said electronic currency acceptor of said dual tender assembly.

11. A method according to claim 10 further comprising the step of programming a time delay in said dual tender assembly wherein, when payment is made via said MDB card reader, activation of said updated vending massage chair is delayed for a pre-set period of time after said payment.
